(19) United States
(12) Patent Application Publication
(10) Pub. No.: US 2020/0224571 A1
(43) Pub. Date: Jul. 16, 2020

(54) REDUCTANT NOZZLE

(71) Applicant: Caterpillar Inc., Deerfield, IL (US)

(72) Inventors: Samprati Vijay Shah, Peoria, IL (US); Satya Ramakrishna Manda Venkata Naga, Dunlap, IL (US); Ian Aguirre, Peoria, IL (US); Arvind Jujare, Peoria, IL (US); Yung T. Bui, Peoria, IL (US); Phillip Kyle Orman, Dunlap, IL (US); Yong Yi, Dunlap, IL (US)

(73) Assignee: Caterpillar Inc., Deerfield, IL (US)

(21) Appl. No.: 16/249,651

(22) Filed: Jan. 16, 2019

(51) Int. Cl. F01N 3/20; B01D 53/94; B05B 1/02

(52) U.S. Cl. CPC F01N 3/2066; B01D 53/9431; F01N 2610/02; F01N 2610/1453; F01N 2570/14; B05B 1/02

(57) ABSTRACT

A nozzle including a nozzle body having a proximal end and a distal end. The proximal end includes at least a first inlet and a second inlet, and the distal end includes an outlet. An inner tube extends in a direction along a central longitudinal axis of the nozzle and at least partly defines a first channel fluidly connected to the first inlet and a second channel fluidly connected to the second inlet. The second channel fluidly connects to the first channel via one or more orifices extending through the inner tube.

### TECHNICAL FIELD

The present disclosure is directed to an exhaust treatment system and, more particularly, to a nozzle that injects a reductant solution into a fluid path within an exhaust treatment system.

### BACKGROUND

Internal combustion engines, such as diesel engines, gasoline engines, gaseous fuel-powered engines, and other engines known in the art, exhaust a complex mixture of components into the environment. These components may include nitrogen oxides (NOx), such as NO and NO₂. Due to an increased focus on avoiding environmental pollution, exhaust emission standards are becoming more stringent, and in some instances, the amount of NOx emitted from engines may be regulated depending on engine size, engine class, and/or engine type. To ensure compliance with the regulation of these components, as well as reduce environmental effects, some engine manufacturers implement a strategy called Selective Catalytic Reduction (SCR). SCR is a process where gaseous and/or liquid reductant, most commonly urea ((NH₂)2CO), is selectively added to engine exhaust using one or more nozzles. The injected reductant decomposes into ammonia (NH₃), reacts with the NOx in the exhaust, and forms water (H₂O) and diatomic nitrogen (N₂).

U.S. Pat. No. 8,356,473 to Blomquist, issued on Jan. 22, 2013 (hereinafter referred to as the '473 reference), describes an injection device having a first conduit for supplying compressed gas, and a second conduit arranged on the outside of the second conduit for supplying a liquid agent. At least one hole extends between the first conduit and the second conduit. As discussed in the '473 reference, liquid agent flows through the at least one hole into the compressed air. The liquid agent is atomized by the compressed gas, mixed with the compressed gas, and transported through an outlet of the injection device for dispersion into an exhaust line.

While the injection device of the '473 reference may attempt to increase the atomization of the liquid agent, the operation of the injection device may be suboptimal. For example, the injection device described in the '473 reference is relatively small in size, and due to the limited internal volume of the device, effective atomization of the liquid agent may be difficult to achieve. In such instances, the non-atomized liquid agent will not react with the NOₓ when injected into the exhaust line, and as a result, the efficiency of the device may be limited. Further, the '473 reference describes an injection device having multiple distinct and assembled parts, and such a device configuration may increase the complexity, assembly time, and/or manufacturing cost of the nozzle. Moreover, such multi-part devices are also often difficult to clean and may become clogged easily.

Example embodiments of the present disclosure are directed toward overcoming one or more of the deficiencies described above.

### SUMMARY OF THE INVENTION

In an example embodiment of the present disclosure, a nozzle comprises a nozzle body having a proximal end and a distal end disposed opposite the proximal end. The proximal end includes a first inlet and a second inlet and the distal end includes an outlet. An inner tube extends along a central longitudinal axis of the nozzle. The inner tube has an inner surface, an outer surface, and a terminal end spaced apart from the proximal end of the nozzle. The inner surface of the inner tube defines at least a portion of a first channel fluidly connected to the first inlet. A second channel is formed at least in part by the nozzle body and is disposed between the outer surface of the inner tube and at least a portion of the nozzle body. The second channel fluidly connects to the second inlet and fluidly connects to the first channel via orifices formed by the inner tube. A chamber is formed at least in part by the nozzle body and is disposed between the terminal end of the inner tube and the distal end of the nozzle. The chamber fluidly connects to the second channel and the outlet.

In another example embodiment of the present disclosure, a nozzle comprises a nozzle body and an inner tube. The nozzle body has a proximal end including at least a first inlet and a second inlet, as well as a distal end including an outlet. The inner tube extends in a direction along a central longitudinal axis of the nozzle, and at least partly defines a first channel fluidly connected to the first inlet and a second channel fluidly connected to the second inlet. The second channel fluidly connects to the first channel via one or more orifices extending through the inner tube.

In yet another example embodiment of the present disclosure, an exhaust system comprises an exhaust pipe configured to receive exhaust from an engine and a nozzle located within the exhaust pipe. The nozzle is configured to receive reductant and air from a supply line. The nozzle includes a nozzle body having a proximal end and a distal end. The proximal end includes a first inlet and a second inlet, and the distal end includes an outlet. The nozzle further includes an inner tube centrally disposed within the nozzle. The inner tube defines at least a portion of a first channel fluidly connected to the first inlet and a second channel fluidly connected to the second inlet.

### BRIEF DESCRIPTION OF DRAWINGS

FIG. 1 is a perspective view of an exhaust treatment system, showing an example nozzle in accordance with an example embodiment of the present disclosure.

FIG. 2 is a perspective view of a proximal end of the nozzle of FIG. 1 in accordance with an example embodiment of the present disclosure.

FIG. 3 is a perspective view of a distal end of the nozzle of FIG. 1 in accordance with an example embodiment of the present disclosure.

FIG. 4 is a side view of the nozzle of FIG. 1 in accordance with an example embodiment of the present disclosure.

FIG. 5 is a plane view of the proximal end of the nozzle of FIG. 1 in accordance with an example embodiment of the present disclosure.

FIG. 6 is a plane view of the distal end of the nozzle of FIG. 1 in accordance with an example embodiment of the present disclosure.

FIG. 7 is a cross-sectional view of the nozzle of FIG. 1 in accordance with an example embodiment of the present disclosure.

FIG. 8 is a perspective view of an example inner tube within an example interior of the nozzle of FIG. 1 in accordance with an embodiment of the present disclosure.

FIG. 9 is a side view of the inner tube of FIG. 8 in accordance with an embodiment of the present disclosure.

FIG. 10 is a detailed view of an example chamber within an example interior of the nozzle of FIG. 1 in accordance with an embodiment of the present disclosure.

FIG. 11 is a cross-sectional view of an example interior of the nozzle of FIG. 1, showing directional flows of air and reductant in accordance with an example embodiment of the present disclosure.

### DETAILED DESCRIPTION

This disclosure generally relates to nozzles useful for injecting a mixture of reductant and air into an exhaust stream. Wherever possible, the same reference number(s) will be used through the drawings to refer to the same or like features. In the figures, the left-most digit(s) of a reference number identifies the figure in which the reference number first appears.

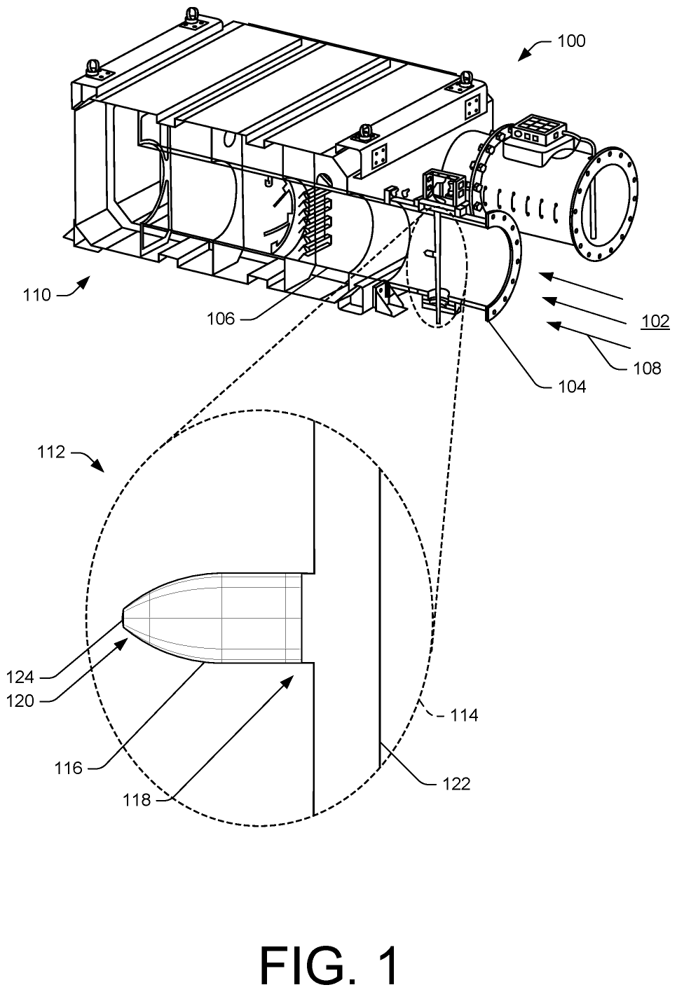

FIG. 1 illustrates an example exhaust system 100. For the purposes of this disclosure, the exhaust system 100 is shown and described in use with a diesel-fueled, internal combustion engine. However, the exhaust system 100 may embody any exhaust system useable with any other type of combustion engine such as a gasoline or a gaseous fuel-powered engine, or an engine fueled by compressed or liquefied natural gas, propane, or methane.

An engine (not shown) may produce exhaust 102, and the exhaust 102 may enter the exhaust system 100 via an exhaust inlet 104 of an exhaust pipe 106. Upon entering the exhaust system 100, the exhaust 102 may pass within the exhaust pipe 106 in the direction indicated by arrows 108. The exhaust 102 may exit the exhaust system 100 via one or more exhaust outlets 110.

The exhaust system 100 may include components that condition byproducts of combustion. For example, the exhaust system 100 may include a treatment system 112 to remove regulated constituents from the exhaust 102 and/or to act on regulated constituents within the exhaust 102. In other words, the exhaust 102 may undergo one or more treatment processes within the treatment system 112 to promote NOx reduction, for example, a conversion of NO to NO₂. A portion of the treatment system 112 is shown in greater detail in the enlarged view 114.

Among other components, the treatment system 112 may include a nozzle 116 configured to spray a reductant solution (or other compound(s)) into the exhaust 102. The nozzle 116 may include a proximal end 118 and a distal end 120 disposed opposite the proximal end 118. The example treatment system 112 may also include a supply line 122. The nozzle 116 may fluidly connect to the supply line 122 at the proximal end 118 of the nozzle 116 and via one or more fittings or couplers. The supply line 122 may be configured to support the nozzle 116 within an inner passage formed by the exhaust pipe 106 and at any location (e.g., a fixed location) within the exhaust pipe 106. In some examples, the nozzle 116 may be disposed substantially centrally within the exhaust pipe 106. In other examples, the nozzle 116 may be disposed proximate and/or adjacent to a wall of the exhaust pipe 106 (e.g., proximate and/or adjacent to a wall forming the inner passage of the exhaust pipe 106).

At the proximal end 118 of the nozzle 116, the nozzle 116 may include one or more inlets configured to receive reductant and/or air from the supply line 122. In some examples, the supply line 122 may include multiple distinct supply lines (e.g., the supply line 122 may comprise a double pipe) such as a compressed air line and a reductant supply line separate from the compressed air line. In such examples, the compressed air line may supply compressed air to the nozzle 116 and the reductant supply line may supply reductant to the nozzle 116. The supply line 122 may supply either a liquid or gaseous reductant to the nozzle 116. For example, the reductant may include an ammonia gas, liquefied anhydrous ammonia, ammonium carbonate, an ammine salt solution, or a hydrocarbon such as diesel fuel, capable of being sprayed or otherwise advanced through one or more spray channel outlets 124 at the distal end 120 of the nozzle 116. In some examples, the spray channel outlets 124 and/or the nozzle 116 may be oriented such that the reductant solution disperses substantially in-line with and/or substantially in the same direction as the flow of the exhaust 102. Additionally, the reductant solution may disperse in a substantially conical-shaped plume from the distal end 120 of the nozzle 116.

The treatment system 112 may also include a compressor (not shown) configured to supply compressed air via the supply line 122, and one or more reservoirs and pumps (not shown) configured to supply reductant via the supply line 122. In some embodiments, an amount of compressed air and/or an amount of reductant supplied may depend on a flow rate of the exhaust 102, an operational state of the engine (e.g., rpm), a temperature of the exhaust 102, a concentration of NOx in the exhaust 102, and/or one or more other operating conditions of the treatment system 112 or of the engine. For example, as the flow rate of the exhaust 102 decreases, a controller or other control component (not shown) operably connected to the pump may control the pump to commensurately decrease the amount of reductant and/or air supplied to the nozzle 116 (and thereby introduced into the exhaust 102). Alternatively, as the flow rate of the exhaust 102 increases, the controller or other control component may increase the amount of reductant and/or air supplied to the nozzle 116.

In some embodiments, the nozzle 116 may be located downstream from an SCR system within the exhaust system 100 and/or other treatment systems. The exhaust system 100 and/or treatment system 112 may also include one or more oxidation catalysts, mixing features, particulate filters (e.g., diesel particulate filter (DPF)), SCR substrates, ammonia reduction catalysts, and other devices configured to further enhance the effectiveness of reducing NOx. Additionally, while only one nozzle 116 is shown coupled to the supply line 122, in some embodiments, the exhaust system 100 and/or the treatment system 112 may include more than one nozzle 116. Moreover, the exhaust system 100 and/or the treatment system 112 may include more than one supply line 122, and the exhaust system 100 may include any number of exhaust pipes 106 having one or more nozzles 116 and/or one or more supply lines 122 positioned therein.

As discussed in detail herein, the nozzle 116 may facilitate mixing of reductant and air to atomize the reductant. More particularly, within an interior of the nozzle 116, air and reductant may mix together to form reductant solution. This process may cause the reductant to break up into fine particles or droplets. As noted above, the nozzle 116 may disperse and/or otherwise direct the reductant solution into the exhaust 102 through the one or more spray channel outlets 124 disposed at the distal end 120 of the nozzle 116. Accordingly, as the reductant solution disperses into the exhaust 102, the reductant solution may react with NOx (e.g., NO and/or NO₂) to form water (H₂O) and elemental nitrogen (N₂).

In some embodiments, the nozzle 116 may be manufactured using 3D printing techniques or other types of additive manufacturing (e.g., cast molding) and comprise a single piece of material. However, it is contemplated that one more of the components of the nozzle 116 discussed above and herein may be alternatively manufactured from other processes. Additionally, the nozzle 116 may be manufactured from a plurality of materials, including chromium, nickel, stainless steel, alloys, ceramics, etc. The materials may also be anti-corrosive and anti-stick to prevent a build-up of the reductant on and/or within the nozzle 116.

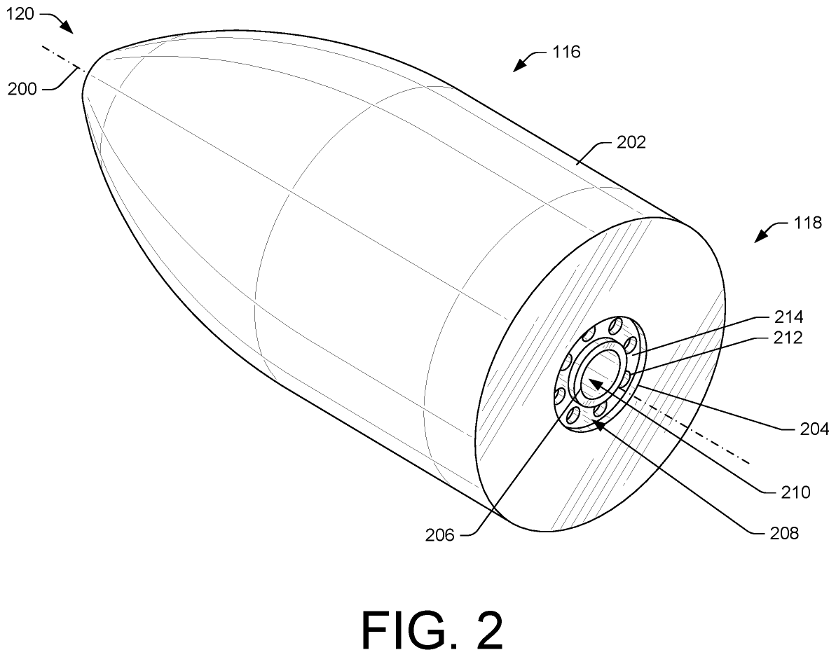

FIG. 2 illustrates a perspective view of the proximal end 118 of the nozzle 116. As shown, the nozzle 116 may extend from the proximal end 118 to the distal end 120, along a longitudinal axis 200 of the nozzle 116. In some instances, the longitudinal axis 200 may be centrally located within the nozzle 116.

The nozzle 116 may include an exterior surface 202 that extends between the proximal end 118 and the distal end 120. The exterior surface 202 may be a substantially continuously smooth surface. As illustrated in FIG. 2, the exterior surface 202 may curve or taper, toward the longitudinal axis 200, as the exterior surface 202 extends from the proximal end 118 to the distal end 120 of the nozzle 116.

The proximal end 118 of the nozzle 116 may include an air channel inlet 204 configured to receive air from the supply line 122. The nozzle 116 may also include a reductant channel inlet 206 that is separate from the air channel inlet 204, and that is configured to receive reductant from the supply line 122. As shown, the air channel inlet 204 may be a substantially annular fluid inlet defined by the nozzle 116. For example, the air channel inlet 204 may extend substantially around the reductant channel inlet 206 and may substantially resemble a ring or annulus that encircles (e.g., is concentric with) the reductant channel inlet 206. The reductant channel inlet 206 may be substantially centrally located within the nozzle 116, substantially aligned with the longitudinal axis 200, and/or substantially concentric with the longitudinal axis 200 of the nozzle 116.

The air channel inlet 204 may fluidly connect to an air channel 208 defined by the nozzle 116. The air channel inlet 204 may be configured to supply the air channel 208 with air received from the supply line 122. Further, the reductant channel inlet 206 may fluidly connect to a reductant channel 210 defined by the nozzle 116. In such examples, the reductant channel inlet 206 may be configured to supply the reductant channel 210 with reductant received from the supply line 122. The proximal end 118 of the nozzle 116 may be configured to couple the nozzle 116 to the supply line 122 via threads included in the proximal end 118, via a snap fit, via a compression fitting, and/or via one or more of the couplers described above to receive compressed air and reductant from the supply line 122.

The air channel 208 and/or the reductant channel 210 may extend from the proximal end 118 of the nozzle 116 towards the distal end 120 of nozzle 116, along the longitudinal axis 200, to direct air and reductant, respectively, into an interior of the nozzle 116. As shown in FIG. 2, the air channel 208 may include holes 212 through which the air may flow to enter the interior of the nozzle 116. The holes 212 may be disposed through a washer 214 (or part of the nozzle 116) that extends between the air channel inlet 204 and the reductant channel inlet 206. Additionally, the holes 212 may be substantially equally spaced around the longitudinal axis 200. Although FIG. 2 illustrates the nozzle 116 including eight holes 212, the nozzle 116 may include more than or less than eight holes 212. Additionally, the washer 214 may be spaced apart from the proximal end 118 of the nozzle 116 along the longitudinal axis 200 at a greater distance or a less distance. As noted above, within the interior, air supplied by the air channel 208 and reductant supplied by the reductant channel 210 may mix to form the reductant solution.

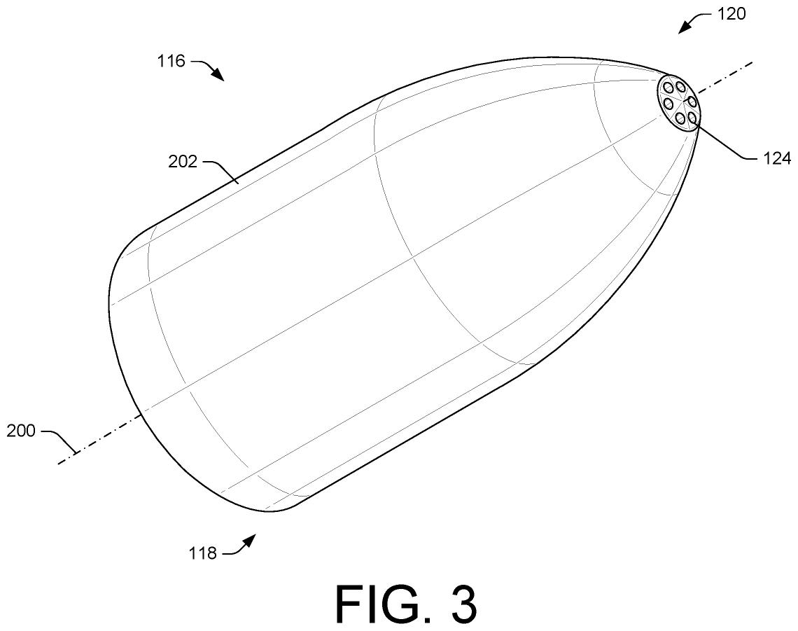

FIG. 3 illustrates a perspective view of the distal end 120 of the nozzle 116. At the distal end 120, the nozzle 116 may include the one or more spray channel outlets 124. As will be discussed herein, a body of the nozzle 116 may form the spray channel outlets 124 on the exterior surface 202 of the nozzle 116. The nozzle 116 may also include respective flow passages and/or channels configured to direct reductant solution from within the interior of the nozzle 116 to one or more of the spray channel outlets 124.

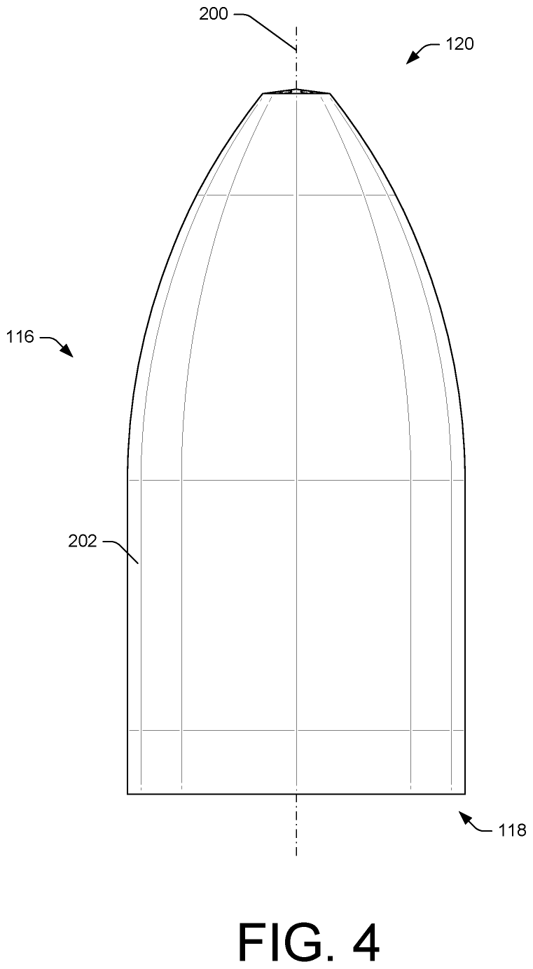

FIG. 4 illustrates a side view of the nozzle 116. As shown in FIG. 4, in some examples, the proximal end 118 of the nozzle 116 may be substantially cylindrically-shaped while the distal end 120 of the nozzle 116 may be substantially conically-shaped or substantially domed-shaped. As such, in some example embodiments the proximal end 118 of the nozzle 116 may have a first cross-sectional area (or distance) as defined by a first plane extending parallel to the longitudinal axis 200, and the distal end 120 of the nozzle 116 may have a second cross-sectional area (or distance) as defined by a second plane extending parallel to the longitudinal axis 200 that is less than the first cross-sectional area (or distance) of the proximal end 118 of the nozzle 116. Additionally, because of the reducing cross-sectional area (or distance), the nozzle 116, or the exterior surface 202, may taper from the proximal end 118 to the distal end 120, along the longitudinal axis 200. Additionally, in some instances, the nozzle 116 may be symmetrical about the longitudinal axis 200 of the nozzle 116.

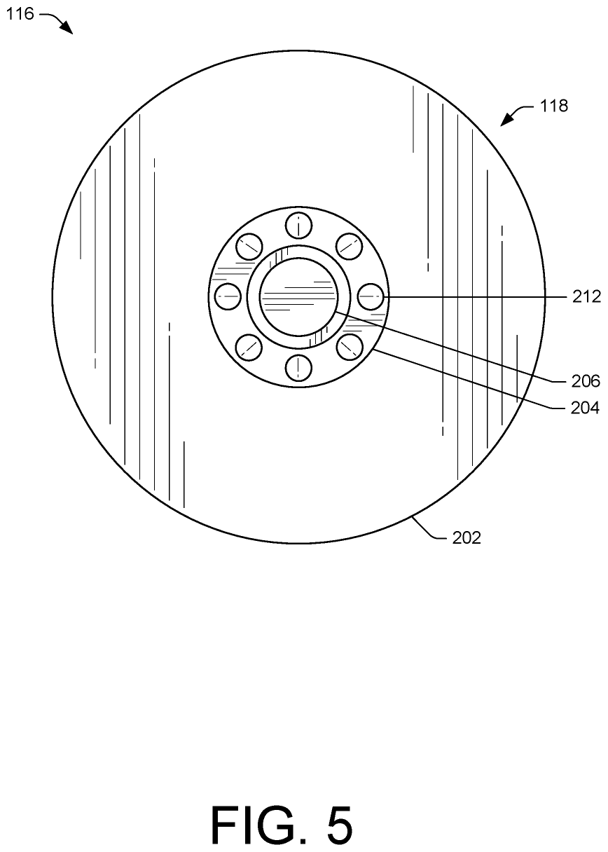

FIG. 5 illustrates a plane view of the proximal end 118 of the nozzle 116. As shown, the proximal end 118 of the nozzle 116 may include the air channel inlet 204 that is configured to receive air from the supply line 122, and the reductant channel inlet 206 that is configured to receive reductant from the supply line 122. In some examples, the air channel inlet 204 may extend substantially around the reductant channel inlet 206 to encircle the reductant channel inlet 206. Additionally, although the holes 212 are shown as being substantially cylindrical, the holes 212 may include alternative cross-sections, such as being substantially ovular, substantially square, substantially trapezoidal, and so forth.

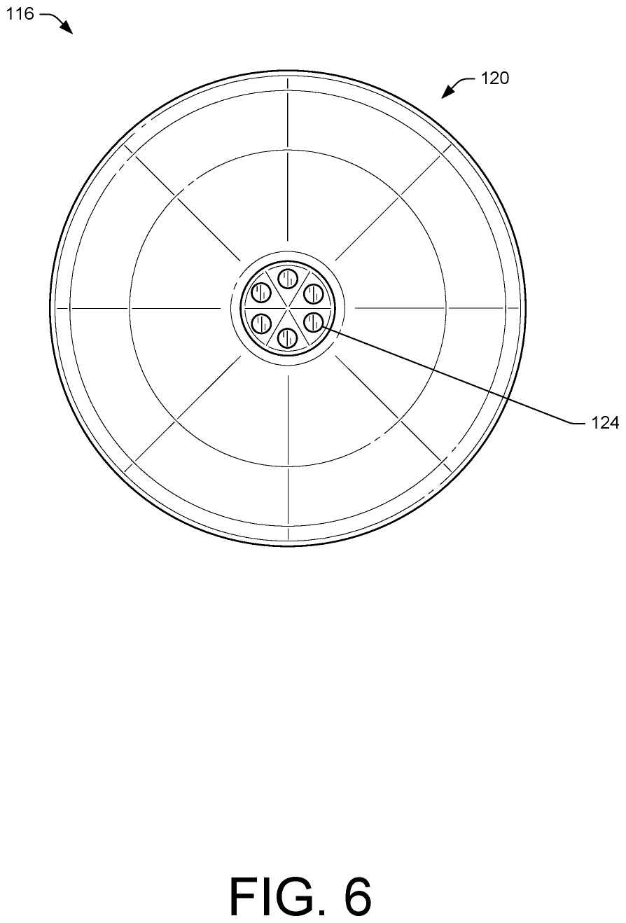

FIG. 6 illustrates a plane view of the distal end 120 of the nozzle 116. As shown in FIG. 6, the spray channel outlets 124 may be substantially evenly distributed around the longitudinal axis 200 of the nozzle 116 such that, for example, pairs of the spray channel outlets 124 may be substantially diametrically opposed from one another. In some instances, the spray channel outlets 124 may be substantially circular, substantially ovular, and/or any other shape. Additionally, while FIG. 6 illustrates a certain number of spray channel outlets 124, the nozzle 116 may include more than or less than six spray channel outlets 124.

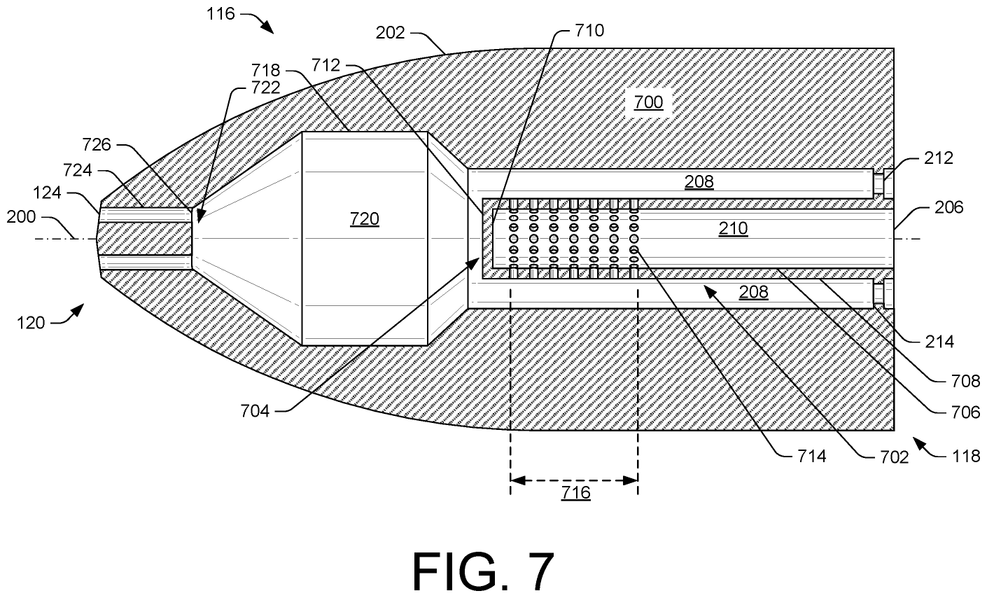

FIG. 7 illustrates a cross-sectional view of the nozzle 116, taken along a plane that defines the longitudinal axis 200 of the nozzle 116. As shown in FIG. 7, the nozzle 116 includes a nozzle body 700 that extends between the proximal end 118 of the nozzle 116 and the distal end 120 of the nozzle 116, and along the longitudinal axis 200 of the nozzle 116. As shown in FIG. 7, the nozzle body 700 may define and/or include an interior, channels, passageways, structures, etc. disposed internal to the exterior surface 202 of the nozzle 116. For instance, as shown in FIG. 7, the nozzle 116 may include an inner tube 702 defined by the nozzle body 700. The inner tube 702 may extend from the proximal end 118 of the nozzle 116 to a terminal end 704 of the inner tube 702, spaced apart from the proximal end 118, and in a direction of the longitudinal axis 200 of the nozzle 116. In some embodiments, the inner tube 702 may comprise a substantially cylindrical, substantially hollow structure, and the inner tube 702 may be substantially centrally located within the nozzle 116. In some instances, the inner tube 702 may couple to the washer 214 such that the air channel 208 is disposed around the inner tube 702. That is, the washer 214 may suspend the inner tube 702 within the nozzle 116, where the air channel 208 encircles the inner tube 702 or the inner tube 702 is disposed within the second channel 208. Additionally, as can be seen in at least FIGS. 2 and 7, the washer 214 may be defined by the nozzle body 700.

The inner tube 702 may define a least a portion of the reductant channel 210. For example, the inner tube 702 may include an inner surface 706 extending from the proximal end 118 of the nozzle 116 to the terminal end 704 of the inner tube 702. The inner surface 706 may define a least a portion of the reductant channel 210.

The inner tube 702 may also include an outer surface 708, radially spaced apart from the inner surface 706 of the inner tube 702 and the reductant channel 210, relative to the longitudinal axis 200 of the nozzle 116. The outer surface 708 may extend, from a position proximal to the washer 214, in a direction along the longitudinal axis 200 of the nozzle 116 towards the terminal end 704 of the inner tube 702. The outer surface 708 of the inner tube 702 may also define at least a portion of the air channel 208.

While FIG. 7 illustrates the washer 214 as being offset from the proximal end 118 of the nozzle 116 at a particular distance along a length of the longitudinal axis 200, in some instances, the washer 214 may be spaced closer to or farther from the proximal end 118 of the nozzle 116. Additionally, as noted above, although FIG. 7 illustrates the nozzle body 700 including the washer 214 and the inner tube 702, other configurations may be implemented as well. For instance, the nozzle body 700 may include pegs, bars, walls, or other protrusions may radially extend from the inner tube 702 to suspend the inner tube 702 within the nozzle 116. These protrusions may be spaced about the longitudinal axis 200 of the nozzle 116, whereby air may flow into the air channel 208 via spaces or gaps interposed between adjacent protrusions.

The terminal end 704 of the inner tube 702 may enclose the reductant channel 210 and may include a first side 710 and a second side 712. The first side 710 may comprise an end of the reductant channel 210, and the first side 710 may be disposed internal to the outer surface 708 of the inner tube 702 and spaced apart from the proximal end 118 of the nozzle 116 along the longitudinal axis 200. The second side 712 may be disposed external to the inner surface 706 of the inner tube 702 or external to the reductant channel 210.

The inner tube 702 may include a thickness extending between the inner surface 706 and the outer surface 708. Orifices 714 may extend through the thickness of the inner tube 702, between the inner surface 706 and the outer surface 708. In some instances, one or more of the orifices 714 may extend substantially perpendicular to the longitudinal axis 200 of the nozzle 116. As a result, the orifices 714 may radially extend through the inner tube 702 relative to the longitudinal axis 200 of the nozzle 116. Additionally, or alternatively, one or more of the orifices 714 may extend at, for example, an acute angle relative to the longitudinal axis 200.

The orifices 714 may extend around a periphery of the inner tube 702, about the longitudinal axis 200 of the nozzle 116. In embodiments in which the orifices 714 extend around a periphery of the inner tube 702, two or more of the respective orifices 714 may be diametrically opposed from one another. Additionally, FIG. 7 illustrates that the orifices 714 may extend along a predetermined length 716 of the inner tube 702, where the length 716 extends in a direction parallel to the longitudinal axis 200 of the nozzle 116. As will be discussed herein, the orifices 714 may be arranged in columns, sets, groups, and/or rows along the length 716 of the inner tube 702. In such examples, respective orifices 714 of the rows, for instance, may circumferentially extend around the inner tube 702 about the longitudinal axis 200 of the nozzle 116.

In some embodiments, the orifices 714 may be substantially similar in size and may be disposed apart from one another by substantially the same distance (e.g., substantially equally spaced along the length 716 of the inner tube 702 and/or substantially equally spaced apart about the longitudinal axis 200). In such embodiments, the orifices 714 may be substantially evenly distributed along the length 716 and/or radially-spaced around the outer surface 708 of the inner tube 702. Furthermore, although FIG. 7 illustrates the nozzle 116 including a particular number of the orifices 714, or the orifices 714 extending along the length 716 of the inner tube 702, the nozzle 116 may include more or less orifices 714 than shown in FIG. 7 and/or the orifices 714 may extend along a different length of the inner tube 702.

As noted above, the nozzle 116 may include the air channel 208, which in some instances, may be defined at least in part by the nozzle body 700. As shown, the air channel 208 may extend from the proximal end 118 of the nozzle 116 towards the distal end 120 of the nozzle 116, and in a direction substantially parallel to the longitudinal axis 200 of the nozzle 116. In some instances, a portion of the air channel 208 may be defined between an interior surface 718 of the nozzle body 700 and the outer surface 708 of the inner tube 702. Additionally, as noted above, FIG. 7 illustrates that the washer 214 may extend through a portion of the air channel 208. The holes 212 may provide a passageway for the air to traverse to enter the interior of the nozzle 116. In other words, the holes 212 may fluidly connect a first portion of the air channel 208 to a second portion of the air channel 208 located external to the interior.

The air channel 208 and the reductant channel 210 may be arranged substantially coaxially in relation to one another such that the air channel 208 and the reductant channel 210 may be substantially concentric with the longitudinal axis 200 of the nozzle 116. For instance, as shown in FIG. 7 the air channel 208 may be arranged around the reductant channel 210, or around at least a portion of the outer surface 708 of the inner tube 702. In other words, the air channel 208 may surround the reductant channel 210 in a substantially concentrically spaced circumscribing relationship.

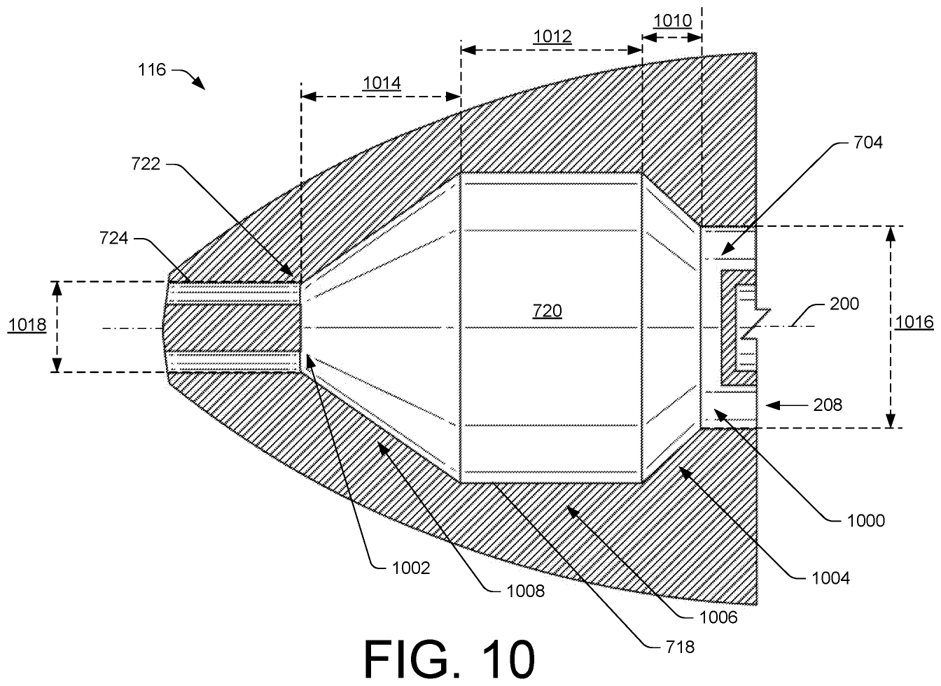

The nozzle 116 may include a chamber 720. In some instances, the chamber 720 may be defined by the interior surface 718 of the nozzle body 700. The chamber 720 may be disposed between an end 722 of the interior of the nozzle 116 and the terminal end 704 of the inner tube 702. Details of the chamber 720 will be discussed herein with regard to FIG. 10.

At the end 722, the nozzle body 700 may define one or more spray channels 724. The one or more spray channels 724 may extend from the interior surface 718 to the exterior surface 202 of the nozzle 116. Individual spray channels 724 may fluidly connect with a respective one of the spray channel outlets 124 located on the exterior surface 202, and a respective one of spray channel inlets 726 located on the interior surface 718 of the nozzle body 700. In some instances, the spray channels 724 may be substantially parallel to the longitudinal axis 200 of the nozzle 116, from respective spray channel inlets 726 to respective spray channel outlets 124. However, in some instances, the spray channels 724 may be oriented away from the longitudinal axis 200 of the nozzle 116 such that the spray channels 724 may angle away from the longitudinal axis 200 of the nozzle 116.

In some instances, the spray channels 724 may include a cross-sectional shape that may resemble a substantially circular shape. Additionally, or alternatively, in some instances, the spray channels 724 may extend in a substantially helical direction about the longitudinal axis 200 of the nozzle 116, or from the spray channel inlets 726 to the spray channel outlets 124. In other words, individual spray channels 724 may include a respective central longitudinal axis (not shown), extending from a respective spray channel inlet 726 to a respective spray channel outlet 124, and the central longitudinal axis of one or more of the respective spray channels 724 may extend substantially helically about the longitudinal axis 200 of the nozzle 116. Additionally, a diameter or cross-section of the spray channels 724, as defined by a plane extending perpendicular to the longitudinal axis of the spray channel 724, may decrease from respective spray channel inlets 726 to respective the spray channel outlets 124 as a result of such a configuration.

The spray channels 724 may also taper along a length of the spray channel 724, between the spray channel inlets 726 and the spray channel outlets 124. For instance, the spray channels 724 may include a first cross-sectional area at the spray channel inlets 726 and a second cross-sectional area at the spray channel outlets 124 that may be less than the first-cross sectional area. As the reductant solution passes from the spray channel inlets 726 to the spray channel outlets 124, the decrease in cross-sectional area causes a velocity of the reductant solution to increase, which may enhance mixing, atomization, and dispersion of the reductant solution within the exhaust 102.

As noted above, the nozzle 116 may fluidly connect to a supply line (e.g., the supply line 122) to receive air and/or reductant. The air channel 208 may be configured to direct air into the interior of the nozzle 116, while the reductant channel 210 may be configured to direct reductant into the interior of the nozzle 116. The orifices 714 extend through the thickness of the inner tube 702 to fluidly connect the reductant channel 210 with the air channel 208. In doing so, the orifices 714 may direct reductant form the reductant channel 210 into the air channel 208, thereby providing passageways through which the reductant may flow. That is, individual orifices 714 may direct a portion of the reductant towards the air channel 208 to substantially uniformly disperse the reductant within the air channel 208. As the reductant traverses the reductant channel 210, from the proximal end 118 of the nozzle 116 towards the distal end 120 of the nozzle 116, in a direction substantially parallel the longitudinal axis 200, the reductant may flow through the orifices 714 and into the air channel 208.

As the reductant moves into the air channel 208, air passing through the air channel 208 may impact the reductant and atomize the reductant. That is, the pressurized air flowing through the air channel 208 may impact the reductant advanced into the air channel 208, via the orifices 714, to breakup the reductant. Given the orientation of the orifices 714 (e.g., perpendicular in relation to the longitudinal axis 200 of the nozzle 116), reductant may flow into the air channel 208 in a direction substantially perpendicular to the flow of air within the air channel 208. As the air channel 208 fluidly connects to the chamber 720, the air channel 208 may open into the chamber 720 to disperse reductant and air into the chamber 720. The air supplied by the air channel 208 may carry the reductant into the chamber 720.

Within the chamber 720, the air and the reductant may mix together, forming a reductant solution. The reductant solution may exit the interior of the nozzle 116 via the one or more spray channels 724 disposed at the distal end 120 of the nozzle 116. Moreover, as noted above, in instances where the spray channels 724 extend substantially helically about the longitudinal axis 200 of the nozzle 116, the reductant solution may exit the spray channel outlets 124 in a spiraling manner, which may assist in further mixing the reductant solution and/or atomize the reductant. The swirling effect of the reductant solution may create a plume of reductant solution large enough to extend to an outer periphery of the exhaust pipe 106, for instance, and may assist in conically spraying the reductant solution into the exhaust 102.

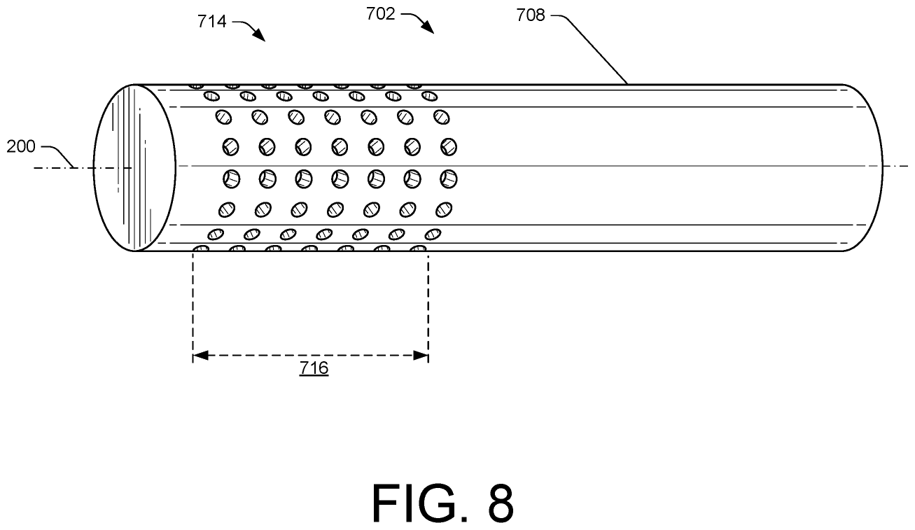

FIG. 8 illustrates a perspective view of the inner tube 702 of the nozzle 116. As shown, the inner tube 702 may include the outer surface 708. Additionally, although the inner tube 702 is shown having a substantially cylindrical shape, in some embodiments, the inner tube 702 may comprise other shapes, such as being substantially hexagonal, substantially square, substantially ovular, and so forth. FIG. 8 further illustrates the orifices 714 may be circumferentially disposed around a periphery of the inner tube 702, about the longitudinal axis 200, and along the length 716 of the inner tube 702.

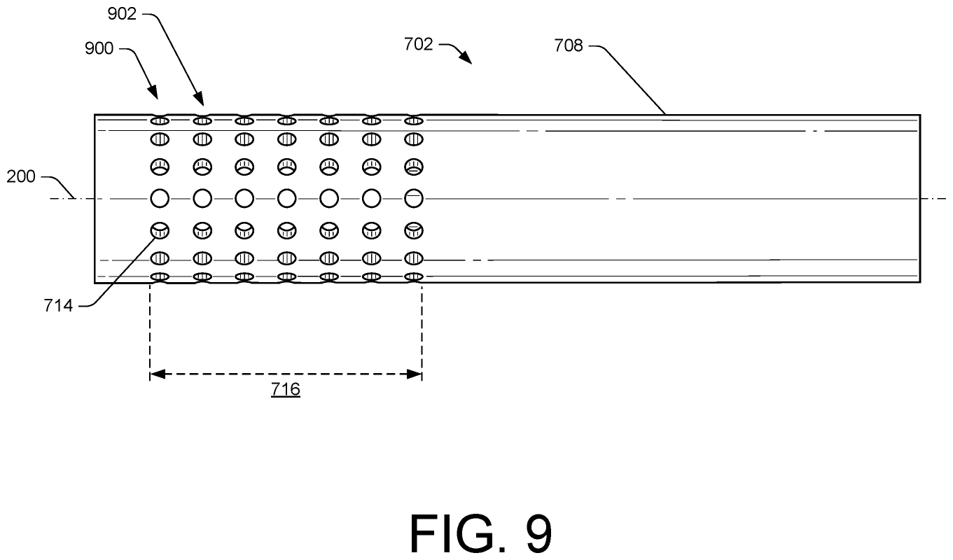

FIG. 9 illustrates a side view of the inner tube 702 of the nozzle 116. The orifices 714 are shown as being distributed along the length 716 of the inner tube 702, in a direction of the longitudinal axis 200 of the nozzle 116. As noted above, the orifices 714 may be arranged in rows spaced along the longitudinal axis 200 of the nozzle 116. For instance, FIG. 9 illustrates that the orifices 714 may be arranged in a first row 900 and a second row 902. The first row 900 may be spaced apart from the second row 902 in a direction substantially parallel to the longitudinal axis 200 of the nozzle 116. Individual orifices 714 of the first row 900 and the second row 902, respectively, may be substantially circumferentially distributed about the longitudinal axis 200 of the nozzle 116. In some instances, the individual orifices 714 of the first row 900 and the individual orifices 714 of the second row 902, respectively, may be substantially equally distributed around the longitudinal axis 200 of the nozzle 116.

Although FIG. 9 illustrates a certain number of the orifices 714 and/or a certain number of rows of the orifices 714 (e.g., the first row 900 and the second row 902), the inner tube 702 may include more orifices 714, less orifices 714, less rows (e.g., one), or more rows (e.g., twelve) than shown in FIG. 9.

FIG. 10 illustrates a detailed view of the chamber 720. The chamber 720 may include an inlet end 1000, and an outlet end 1002 axially spaced apart from the inlet end 1000 along the longitudinal axis 200 of the nozzle 116. The chamber 720 may be disposed between the terminal end 704 of the inner tube 702 and the end 722 of the interior. The terminal end 704 may be adjacent to the inlet end 1000 of the chamber 720 and the end 722 of the interior may represent and/or correspond to the outlet end 1002 of the chamber 720. Accordingly, at the inlet end 1000 of the chamber 720, the chamber 720 may receive reductant solution from the air channel 208, while at the outlet end 1002, the chamber 720 may fluidly connect to the spray channels 724.

In some instances, the chamber 720 may include multiple portions having various cross-sectional dimensions, shapes, and so forth. As an example, the chamber 720 may include varying cross-sectional dimensions as the chamber 720 axially extends from the inlet end 1000 to the outlet end 1002 along the longitudinal axis 200 of the nozzle 116. For instance, the chamber 720 may include a first portion 1004, a second portion 1006, and/or a third portion 1008. The first portion 1004, the second portion 1006, and the third portion 1008 may fluidly connect to form the chamber 720. However, the chamber 720 may include more than or less than three portions as illustrated in FIG. 10.

The first portion 1004 may be disposed at the inlet end 1000 of the chamber 720, the third portion 1008 may be disposed at the outlet end 1002 of the chamber 720, and the second portion 1006 may be interposed between the first portion 1004 and the third portion 1008. As shown in FIG. 10, the first portion 1004 may outwardly taper away from the longitudinal axis 200 of the nozzle 116, as the first portion 1004 extends towards the second portion 1006 of the chamber 720, thereby increasing in cross-sectional area. In such examples, the first portion 1004 may resemble a substantially frustoconical shape. The second portion 1006 may in some instances include a constant cross-sectional area as the second portion 1006 axially extends along the longitudinal axis 200 and toward the third portion 1008 of the chamber 720. The second portion 1006 may therefore resemble a substantially cylindrical shape. The third portion 1008 of the chamber 720 may inwardly taper towards the longitudinal axis 200 of the nozzle 116, as the third portion 1008 extends from the second portion 1006 towards the outlet end 1002 of the chamber 720. In such examples, the third portion 1008 may resemble a substantially frustoconical shape and may reduce in cross-sectional area to funnel the reductant solution towards the spray channels 728.

Additionally, in some instances, a first longitudinal length 1010 (along the longitudinal axis 200 of the nozzle 116) of the first portion 1004 may be less than a second longitudinal length 1012 (along the longitudinal axis 200 of the nozzle 116) of the second portion 1006 and/or a longitudinal length 1014 (along the longitudinal axis 200 of the nozzle 116) of the third portion 1008. The second longitudinal length 1012 of the second portion 1006 may also be less than the third longitudinal length 1014 of the third portion 1008.

In some instances, the inlet end 1000 of the chamber 720 may include a first cross-sectional dimension 1016 extending between diametrically opposed points on the interior surface 718 of the nozzle body 700. The outlet end 1002 of the chamber 720 may include a second cross-sectional dimension 1018 extending between diametrically opposed points on the interior surface 718 that is less that the first cross-sectional dimension 1016. As the chamber 720 extends from the inlet end 1000 towards the outlet end 1002, the chamber 720 may guide and accelerate the reductant solution towards the spray channels 724. That is, because the second cross-sectional dimension 1018 may be less than the first cross-sectional dimension 1016, a velocity of the reductant solution passing through the chamber 720 may increase.

Additionally, the chamber 720 may permit the reductant solution to expand and potentially reduce a crystallization of the reductant solution within the nozzle 116. For instance, the expansion of the reductant solution may occur as a result of the first portion 1004 outwardly tapering from the longitudinal axis 200 and increasing in cross-sectional area. The chamber 720 may also impart a swirling motion into the reductant solution to increase a mixing of the reductant and the air, or to further atomize the reductant within the nozzle 116.

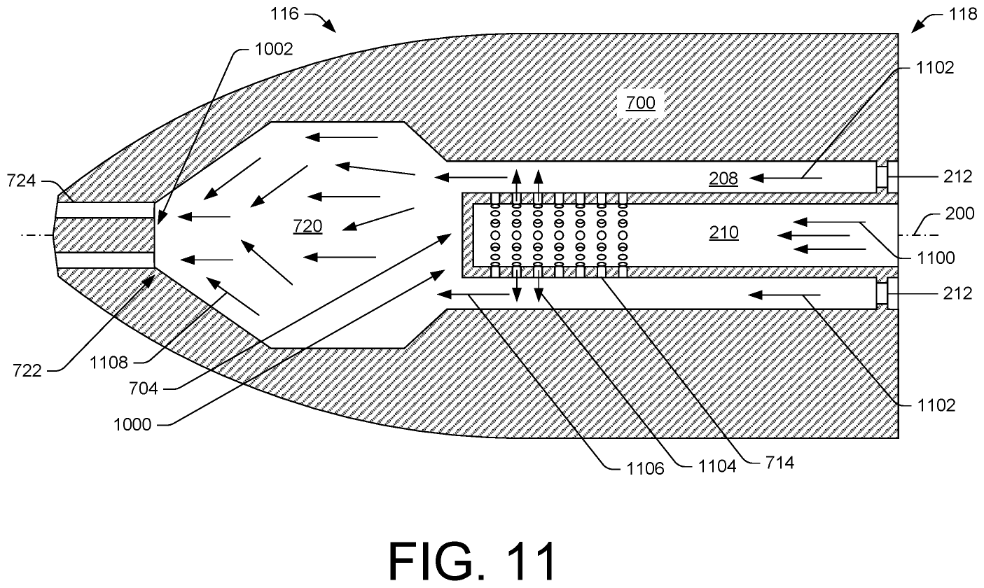

FIG. 11 illustrates a cross-sectional view of the nozzle 116 showing a flow pattern of reductant and air within the nozzle 116. The cross-sectional view of FIG. 11 is taken along the longitudinal axis 200 of the nozzle 116 and through two spray channels 724. As illustrated in FIG. 11, and as discussed previously, the reductant channel 210 may direct reductant into the nozzle 116 in a direction substantially parallel to the longitudinal axis 200 of the nozzle 116, as shown by arrows 1100. The air channel 208 may direct air into the nozzle 116, in a direction substantially parallel to the longitudinal axis 200 of the nozzle 116, as shown by arrows 1102. From the proximal end 118, the air may flow through the holes 212 disposed within the air channel 208 to enter the interior of the nozzle 116. As the reductant flows towards the terminal end 704 of the inner tube 702, the reductant may exit the reductant channel 210 via the orifices 714. In other words, the reductant supplied by the supply line 122 may exit the reductant channel 210 and into the air channel 208, as shown by the arrows 1104.

Air flowing through the air channel 208 may impact the reductant exiting the orifices 714. The impact of the air with the reductant may cause the reductant to atomize. Additionally, the air may direct a reductant solution (e.g., a mixture of air and reductant) towards the chamber 720 of the nozzle 116, as shown by arrows 1106.

The air and reductant may enter the chamber 720 at the inlet end 1000. Within the chamber 720, air and reductant may mix to form the reductant solution. The mixing may also atomize the reductant. Within the chamber 720, the reductant solution may funnel toward the outlet end 1002, or toward the end 722 of the nozzle body 700. The reductant solution may therefore flow toward the spray channels 724 and along the longitudinal axis 200 of the nozzle 116, as shown by arrows 1108. Additionally, the varying cross-sectional dimensions of the chamber 720 and the tapering of the chamber 720 (e.g., the third portion 1008) may increase a velocity (e.g., a flow rate) of the reductant solution passing through the chamber 720 and exiting the nozzle 116.

### INDUSTRIAL APPLICABILITY

The exhaust system of the present disclosure may be used with any power system having a treatment system to reduce the amount of harmful emissions generated from internal-combustion engines. More particularly, nozzles of the present disclosure may be used in any liquid/gas mixing operation where efficient, even, and thorough mixing of reductant, air, and exhaust is desired. Although applicable to a range of treatment devices/systems, in some instances, the disclosed treatment system and/or nozzles may be utilized in conjunction with an SCR device. The disclosed nozzle assists in the reduction of NOx by effectively atomizing reductant, and dispersing a mixture of reductant and air in an exhaust gas flow of the engine.

As described above, in some examples the air channel 208 and the reductant channel 210 may supply air and reductant, respectively, into an interior of the nozzle 116. The reductant channel 210 may at least be partially defined by the inner tube 702 that extends into the interior. Within the nozzle 116, the orifices 714 disposed through the inner tube 702 may fluidly connect the air channel 208 and the reductant channel 210. As a result, reductant may exit the reductant channel 210 and enter the air channel 208. As the air channel 208 may be disposed around the reductant channel 210, the air may impact the reductant exiting the orifices 714 and atomize the reductant. The reductant and air solution may advance into the chamber 720 of the nozzle 116 where the air and reductant may mix together. The chamber 720 may inwardly and outwardly taper towards the distal end 120 of the nozzle. The distal end 120 may include the spray channels 724 that extend between the chamber 720 and the exterior surface 202 of the nozzle 116. The tapering of the chamber 720 may increase a velocity of the reductant solution as the reductant solution exits the chamber 720 through the spray channels 724.

The example nozzles 116 discussed herein may increase the atomization of reductant, which may facilitate increased NOx reduction. For instance, conventional nozzles may be configured to direct reductant to impact one or more impinging surfaces internal to the nozzle before the reductant is injected by the nozzle into an exhaust flow. However, such impinging surfaces may fail to adequately atomize reductant or may unevenly distribute reductant within the nozzle for mixing with air. The example nozzles of the present disclosure, on the other hand, may utilize impinging air to atomize the reductant. Such a configuration may improve (e.g., increase) the atomization of reductant, and may assist in substantially uniformly mixing the air and reductant within the nozzle. That is, using a plurality of orifices fluidly connected between an air supply line and a reductant supply line (e.g., the orifices 714), the air may impact the reductant to atomize and substantially evenly mix with the reductant. Additionally, the nozzle 116 may include a chamber (e.g., the chamber 720) configured to assist in minimizing the crystallization of the reductant solution within the nozzle 116, thereby increasing the useful life of the nozzle 116.

It will be apparent to those skilled in the art that various modifications and variations can be made to the exhaust system of the present disclosure without departing from the scope of the disclosure. Other embodiments will be apparent to those skilled in the art from consideration of the specification and practice of the exhaust system disclosed herein. It is intended that the specification and examples be considered as exemplary only, with a true scope of the disclosure being indicated by the following claims and their equivalent.

What is claimed is:

1. A nozzle, comprising:
a nozzle body having a proximal end and a distal end, wherein the proximal end includes a first inlet and a second inlet, and wherein the distal end is disposed opposite the proximal end and includes an outlet;
an inner tube extending along a central longitudinal axis of the nozzle, the inner tube having an inner surface, an outer surface, and a terminal end spaced apart from the proximal end of the nozzle, the inner surface defining at least a portion of a first channel fluidly connected to the first inlet;
a second channel formed at least in part by the nozzle body, wherein the second channel is disposed between the outer surface of the inner tube and at least a portion of the nozzle body, the second channel fluidly connecting to the second inlet and fluidly connecting to the first channel via orifices formed by the inner tube; and
a chamber formed at least in part by the nozzle body, wherein the chamber is disposed between the terminal end of the inner tube and the distal end of the nozzle, the chamber fluidly connecting to the second channel and the outlet.

2. The nozzle of claim 1, wherein the orifices are circumferentially disposed around the inner tube, the orifices comprising at least a first row of orifices and a second row of orifices spaced from the first row of orifices.

3. The nozzle of claim 1, wherein the chamber includes:
an inlet end fluidly connected the second channel,
an outlet end fluidly connected to the outlet,
a first portion at the inlet end,
a second portion, and
a third portion at the outlet end, the second portion being interposed between the first portion and the second portion, the chamber being configured such that the first portion tapers radially outwardly from a first location proximate the inlet end to a first end of the second portion, and the third portion tapers radially inwardly from a second end of the second portion to a second location proximate the outlet end.

4. The nozzle of claim 3, wherein:
the inlet end of the chamber includes a first cross-sectional area extending between diametrically disposed points on an interior surface of the nozzle body; and
the outlet end of the chamber includes a second cross-sectional area extending between diametrically disposed points on the interior surface of the nozzle body, the second cross-sectional area being less than the first cross-sectional area.

5. The nozzle of claim 1, wherein the second channel is disposed around the first channel.

6. The nozzle of claim 1, wherein the inner tube is supported within the nozzle by one or more protrusions coupled to the nozzle body, the one or more protrusions at least partially extending through the second channel.

7. A nozzle, comprising:
a nozzle body having a proximal end and a distal end, the proximal end including at least a first inlet and a second inlet, the distal end including an outlet; and
an inner tube extending in a direction along a central longitudinal axis of the nozzle, the inner tube at least partly defining:
a first channel fluidly connected to the first inlet, and
a scond channel fluidly connected to the second inlet, wherein the second channel is fluidly connected to the first channel via one or more orifices extending through the inner tube.

8. The nozzle of claim 7, wherein:
the inner tube is disposed within the second channel;
the central longitudinal axis extends substantially centrally through the first channel; and
the central longitudinal axis extends substantially centrally through the second channel.

9. The nozzle of claim 7, wherein the inner tube includes:
a length extending along a direction of the central longitudinal axis;
an inner surface defining at least a portion of the first channel; and
an outer surface defining at least a portion of the second channel.

10. The nozzle of claim 7, wherein the one or more orifices are circumferentially disposed around the inner tube and about the central longitudinal axis.

11. The nozzle of claim 7, wherein at least a portion of the one or more orifices are oriented perpendicular to the central longitudinal axis.

12. The nozzle of claim 7, wherein:
the inner tube includes a terminal end spaced apart from the proximal end of the nozzle; and
the nozzle further comprises a chamber interposed between the terminal end of the inner tube and the distal end of the nozzle.

13. The nozzle of claim 12, wherein:
the chamber includes an inlet end disposed adjacent to the terminal end of the inner tube and an outlet end disposed adjacent to the distal end of the nozzle;
the inlet end includes a first cross-sectional area extending between diametrically opposed points on an interior surface of the nozzle body; and
the outlet end includes a second cross-sectional area extending between diametrically opposed points on the interior surface of the nozzle body, the second cross-sectional area being less than the first cross-sectional area.

14. The nozzle of claim 7, wherein:
the one or more orifices comprise at least a first row of orifices and a second row of orifices; and
the first row of orifices is spaced from the second row of orifices in a direction along the central longitudinal axis.

15. The nozzle of claim 14, wherein:
individual orifices of the first row of orifices are substantially equally spaced about the central longitudinal axis; and
individual orifices of the second row of orifices are substantially equally spaced about the central longitudinal axis.

16. The nozzle of claim 7, wherein:
the outlet at the distal end of the nozzle comprises one or more outlets; and
the one or more outlets are substantially equally distributed about the central longitudinal axis of the nozzle.

17. An exhaust system, comprising:
an exhaust pipe configured to receive exhaust from an engine; and
a nozzle located within the exhaust pipe, the nozzle configured to receive reductant and air from a supply line, the nozzle comprising:
a nozzle body having a proximal end and a distal end, the proximal end including a first inlet and a second inlet, the distal end including an outlet; and
an inner tube centrally disposed within the nozzle, the inner tube defining at least a portion of a first channel fluidly connected to the first inlet and a second channel fluidly connected to the second inlet.

18. The exhaust system of claim 17, wherein the second channel fluidly connects to the first channel via orifices disposed through the inner tube.

19. The exhaust system of claim 18, wherein:
the orifices comprise a first row of orifices and a second row of orifices spaced from the first row of orifices;
individual orifices of the first row of orifices are substantially equally spaced around the central longitudinal axis of the nozzle; and
individual orifices of the second row of orifices are substantially equally spaced around the central longitudinal axis of the nozzle.

20. The exhaust system of claim 17, wherein:
the first channel is centrally disposed within the nozzle; and
the second channel is centrally disposed within the nozzle.
